(19) United States
(12) Patent Application Publication
(10) Pub. No.: US 2006/0088032 A1
(43) Pub. Date: Apr. 27, 2006

(54) Method and system for flow management with scheduling

(76) Inventor: Bradley Venables, Nepean (CA)

Correspondence Address: GOWLING LAFLEUR HENDERSON, LLP, Suite 2600, 160 Elgin Street, Ottawa, ON, K1P 1C3, CA

(21) Appl. No.: 11/258,101

(22) Filed: Oct. 26, 2005

Related U.S. Application Data
(60) Provisional application No. 60/621,651, filed on Oct. 26, 2004.

(51) Int. Cl. H04L 12/56

(52) U.S. Cl. 370/395.4

(57) ABSTRACT

Method and System for flow management with scheduling is provided. The system includes a traffic shaper/scheduler, a system monitor, and a modification amount register (MAR) module. The traffic shaper/scheduler implements scheduling algorithm to arbitrate between flows. The system monitor monitors the flows and generates modification request for a target flow to update the MAR. The MAR may be consumed by the scheduling algorithm when the flow associated with the MAR is selected in a scheduling event.

### FIELD OF INVENTION

The present invention relates to the field of network communications, and more specifically to flow management with scheduling for arbitrating between flows.

### BACKGROUND OF THE INVENTION

Routers and switches are well known devices for managing the flow of packets in a communications network. As will be apparent to one skilled in the art, such devices may include, among other things, a rate scheduler (shaper) for limiting the rate of data transmitted to an end user, a network, or an access network or between networks.

One known technique for managing the flow of packets is to utilize flow control. Traditional flow control (i.e. XON/XOFF or credit), however, is generally inappropriate for rate schedulers such as dual rate (e.g. dual leaky token) or single rate with burst capability (e.g. leaky bucket) to name a few. This is because such rate schedulers have memory built in which will allow a burst of data after a period of flow control, potentially nullifying the impacts of the flow control event.

Interference traffic flow control is also undesirable as the interference traffic taxes the scheduling system, which implements the rate shaping, with extra or idle data transmission events which are not carrying data valuable to the end users of the networks. As will be appreciated by one of skill in the art, these extra or idle data transmissions represent a lost opportunity for the network provider to deliver data which is valuable to an end user.

Therefore, there is a need for a method and system for efficiently managing a flow's scheduling treatment within a scheduling mechanism.

### SUMMARY OF THE INVENTION

It is an object of the invention to provide a method and system that obviates or mitigates at least one of the disadvantages of existing systems.

In accordance with an aspect of the present invention there is provided a system for data transmission, including: a scheduler for implementing scheduling to select a data flow for transmission; a system monitor for determining one or more than one target flow and a modification amount for each target flow; and a modification amount register for holding the total modification amount for each target flow as the system monitor requests modification and the scheduler consumes the modification, the scheduler being configured with the transmission characteristics of each flow including the one or more than one target flow, to select the transmission order of flows independently of the modification amount register, and being capable of altering the transmission characteristics of a selected flow which is a target flow, based on the modification amount stored in the modification amount register of the target flow.

In accordance with a further aspect of the present invention there is provided a method for data transmission, including the steps of: at a scheduler, implementing scheduling to select a data flow for transmission; determining one or more than one target flow for an application and a modification amount for each target flow, and generating a modification request associated with the modification amount, independently of the scheduling; and updating a modification amount register for each target flow based on the modification request, independently of the scheduling, to modify the behavior of the scheduler using the modification amount register of a target flow when the scheduler selects the target flow for the transmission

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a block diagram showing a flow transmission system in accordance with an embodiment of the invention;

FIG. 2 is a block diagram showing an example a portion of the traffic shaper/scheduler of FIG. 1 and a MAR module applied to the traffic shaper/scheduler; and

FIG. 3 is a block diagram showing a further example of the rate scheduler of FIG. 1.

### DETAILED DESCRIPTION OF THE PREFERRED EMBODIMENT(S)

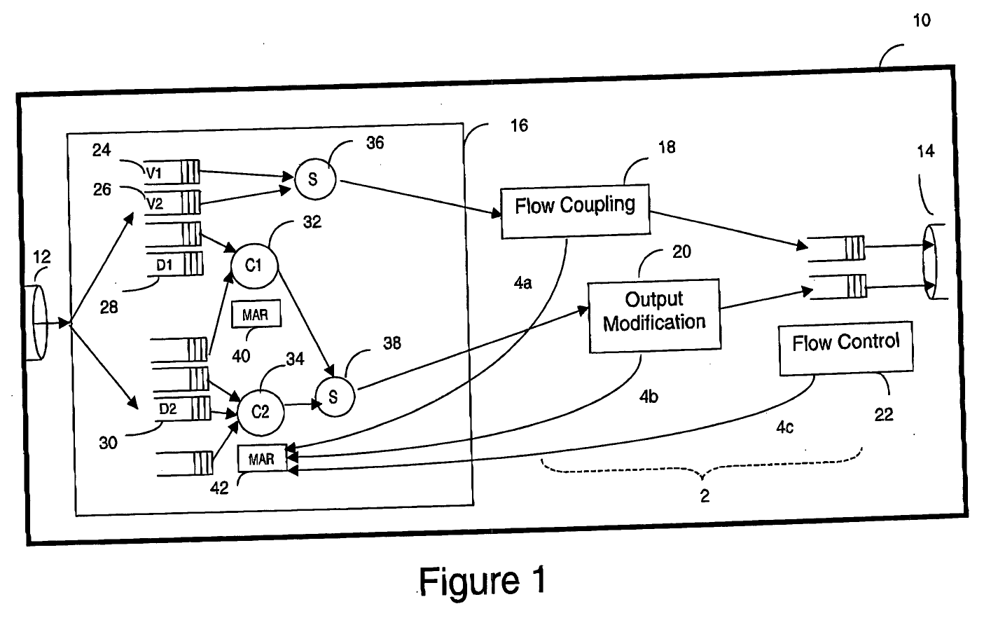

FIG. 1 shows a flow transmission system 10 in accordance with an embodiment of the invention. The flow transmission system 10 includes an input 12, an output 14, and a traffic shaper/scheduler 16. Data/packets are transferred from the input 12 to the output 14 under the control of the traffic shaper/scheduler 16. The traffic shaper/scheduler 16 includes a module for implementing a scheduling algorithm, for example, for rate scheduling bit rate, byte rate, block rate, cell rate or frame rate.

A voice flow or other latency sensitive flow arriving at the input 12 is queued in a voice queue within the traffic shaper/scheduler 16. In FIG. 1, a first voice queue 24 for a first voice flow (not shown) and a second voice queue 26 for a second voice flow (not shown) are illustrated as examples of the voice queue. Data arriving at the input 12 is queued in a data queue within the traffic shaper/scheduler 16. In FIG. 1, a first data queue 28 associated with a first customer (or entity) 32, and a second data queue 30 associated with a second customer (or entity) 34 are illustrated as examples of the data queue. In the description, the terms “customer”, “(rate) scheduled entity”, and “(rate) shaped entity” may be used interchangeably

In FIG. 1, the voice queues 24 and 26 and the data queues 28 and 30 are shown. However, the types of flows associated with the queues are not limited to voice and data. Further, the number of the queues in the traffic shaper/scheduler 16 is not limited to that of FIG. 1, and is changeable. The number of data flows may depend, among other things, on the number of quality of service levels offered by the service provider.

The tic shaper/scheduler 16 includes one or more than one scheduler or shaper. In FIG. 1, a scheduler 36 for the voice flow and a rate scheduler 38 for the data flow are shown. In the description, “rate shaper” and “rate scheduler” maybe used interchangeably. The rate scheduler 38 may be provided for one or more customers. The data queues 28 and 30 for the customers 32 and 34 are rate-scheduled/shaped by the rate scheduler 38. The scheduler 36 may include a scheduler other than a rate scheduler, such as a weighted fair scheduler. In FIG. 1, non-cascaded schedulers 36, 38 are shown as examples. However, these schedulers 36 and 38 maybe cascaded schedulers, where they represent part of a scheduling hierarchy.

The flow transmission system 10 includes a modifier for modifying the behavior of a scheduling instance (e.g. rate scheduler 38) in the traffic shaper/scheduler 16. The modifier includes a system monitor 2 for monitoring transmission flows for the conditions which trigger modifications. The system monitor 2 determines a target flow (e.g. customer) requiring flow management and a modification amount for the target flow. The system monitor 2 outputs a modification request message(s) (4a, 4b, 4c) containing the modification amount, and the target flow. In FIG. 1, the system monitor 2 is located in the downstream direction of data flow. However, the system monitor 2 or any part of the system monitor 2 may be integrated into the traffic shaper/scheduler 16.

The modifier includes at least one modification amount register (MAR) for tracking the modification amount for at least one target flow. The shaper/scheduler 16 incorporates the amount of the MAR into its scheduling algorithm when the flow corresponding to the MAR is selected in a scheduling event. The amount of the MAR is fully or partially consumed in the scheduling event. For example, the amount of data used in the rate/fairness calculation is modified based on the amount of the MAR and the amount contained in the MAR is modified accordingly.

In FIG. 1, MAR 40 for the customer C1 and MAR 42 for the customer C2 are shown as examples. In FIG. 1, the MAR 42 is consumed by the rate scheduler 38. The MAR 42 effects a change in rate in a manner similar to that of a change in packet length of the currently scheduling packet.

The MAR may be consumed by a weighed fair scheduler where the MAR affects a change in remaining weight or deficit in weight in the same way as that of a change in packet length of the currently scheduling packet

The MAR is modified based on the modification request message 4 feedback from the system monitor 2. The amount of the MAR is modified independently of the rate scheduler algorithm's active context and the incorporation of the amount of the

MAR into the scheduler algorithm. Further, at independent times the MAR can also be modified by the scheduling algorithm.

The system monitor 2, the rate scheduler 38 or a combination thereof may request a decrease/increase in the amount of data from the customer. In this case, the amount of the MAR will be increased/decreased. As the shaper/scheduler 16 incorporates the MAR back into the flow's transmission characteristics, the MAR will be worked back towards zero. In this embodiment, the MAR is byte count. However, in another embodiment, the MAR may be used to store a new rate, a bit count or data other than byte count. For example, the context of the MAR may be, but is not limited to, a difference between the amount of data observed by the shaper/scheduler 16 and the amount of data that needs to be included within the shaped rate.

Two MARs are shown in FIG. 1. However, one or more than one MARs may be provided to the shaper/scheduler 16. Further, the MAR may be shared by a plurality of shaped entities If a customer flow is not required to respond to the modification request, the shaper/scheduler algorithm may ignore the amount of the MAR, notwithstanding that the MAR may be used by another customer sharing the rate scheduler (e.g. 38).

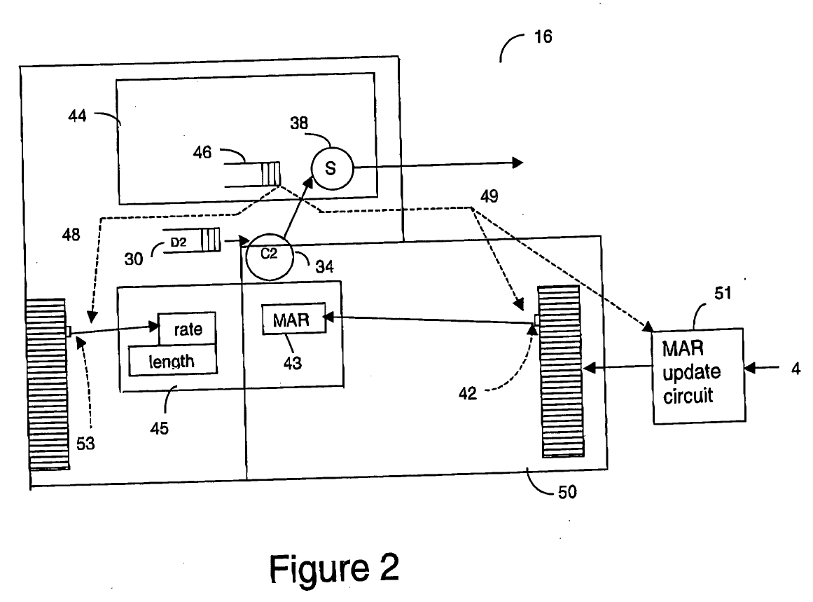

In a typical implementation of a rate scheduler, the rate scheduler 38 calculates a single future scheduling time per customer and uses the scheduling time as a trigger to both send data from the corresponding customer and to execute an algorithm which determines the next scheduling time for the customer. Because of scalability and complexity concerns, this arbitration between customers is typically an O(1) (order 1) algorithm, where the time to execute the algorithm does not increase in proportion to how many customers are sharing the same rate shaper algorithm. As an O(1) algorithm, the rate scheduler typically only updates the parameters of one customer or shaped entity per transmission event and does not modify future scheduling times after they are initially calculated. In order to maintain these key characteristics of the rate scheduler, the MAR is used as a temporary storage of modification requests until the rate scheduler algorithm awakens the customer in the normal O(1) process of advancing time. The MAR allows parameters to be updated during the customer selection event by a rate scheduler (e.g. 38 of FIG. 1, 44 of FIG. 2). The parameters may include, for example but are not limited to, a change in the amount of data which the shaper/scheduler 16 believes to have been transmitted in previous packet transmission events. The content of the respective MAR is fully or partially consumed into the per-customer state and future behavior.

The flow management using a feedback mechanism with MAR does not require a fundamental change to the rate shaping methodology, and can minimize disruption to the methodology. The modification mechanism can be used as an overlay feature. The shaper/scheduler 16 can continue to use the rate shaping methodology, and add the ability to remain fair while receiving flow management events. The system monitor 2 does not need to know the fundamental architecture of the shaper/scheduler 16 or the parameters of the flow within the rate scheduler's capabilities. The rate scheduler does not need to know the goals of the flow management by the system monitor 2 explicitly, but rather the rate scheduler uses its existing fairness and rate calculation while incorporating the modification request messages from the system monitor 2 through the MAR. The underlying fairness and burstiness of the rate shaping method will be changed only when this is modified by a flow management event.

The flow management mechanism allows the rate scheduling algorithm to determine the effect of the flow management, based on the configured parameters of the flow and the magnitude and frequency of the flow management. The effect of the flow management may be to change the shaped rate to a lower rate, insert a time gap in the flow, or reduce the available burst capacity and continue transmitting. To effect this behavior, the flow management event communicates a severity to a rate scheduler (e.g. 38), either through an accumulation of flow management events or through an explicit indication of severity. The rate scheduler incorporates the flow management events into its rate calculations for the flow and the flow may incur a reduction in rate or a time gap due to the calculation.

The flow management is applicable to some scheduler implementations where the goal of the scheduler is weighted fairness between scheduled flows. A scheduling system in the shaper/scheduler 16 can gain benefit from using the same flow control method for both shaped flows and scheduled flows. In fact, there are scheduler implementations which have elements of both scheduled fairness and rate limits. The flow management is applicable to scheduler implementations which have elements of both scheduled fairness and rate limits.

The costs associated with both physical device and resources to implementation are similar after adding the flow management mechanism as before adding the flow management mechanism. The order of complexity of the scheduling algorithm remains unchanged and the increase in memory size and bandwidth controlled. A small change is added to the scheduling algorithm to incorporate the collected modification messages.

The system monitor 2 is now described in detail. The system monitor 2 examines modifies or assesses the system impacts of transmitted data.

The flow management may be triggered by a transmission event from a coupled flow. The flows are selected for transmission based on scheduling, but the flow management makes them appear to share rate limits. In this case, multiple flows are restricted to an aggregate rate.

The system monitor 2 may be a transmission monitor that counts the bytes transmitted for a flow or any other element of the system which is aware of the packet sizes, and feeds back the byte counts or packet sizes as flow control events. In this case, block, cell or frame acrate rate schedulers are modified to become byte accurate or bit accurate.

The system monitor 2 may be a modification engine, which can feedback differences in frame length to the traffic shaper/scheduler 16. In this case, the rate scheduler is informed of downstream modification of fame lengths in order to remain rate accurate to the post modification data size.

A flow coupling module 18 of FIG. 1 embodies one exemplary application for the flow management The flow coupling module 18 provides flow coupling by applying the amount of data sent by one or more flows to the MAR of a target flow. The flow coupling module 18 may use an identifier of the one or more flows to calculate or lookup the identifier of the target flow. In this case, the one or more flows and the target flow may together represent a customer, and the scheduling behaviors of the target flow may represent the overall customer fairness or rate limit.

The target flow may be configured with a rate limit which is at least as large as the rate achieved by all of the one or more flows coupled into the target flow. The target flow may be configured with a rate limit which is at least twice as large as the rate achieved by all of the one or more flows coupled into the target flow, and the MAR may be dimensioned to accommodate at least as much data as the maximum transmission unit of the customer.

The one or more flows being coupled into the target flow may be jitter sensitive data, and the target flow may be the rest of the customer data which is less jitter sensitive. The one or more flows being coupled into the target flow may include voice packets.

The flow coupling module 18 sends a modification request message 4a in response to forward data transmission on a coupled flow. For example, if data transmitted from the voice queue 24 is supposed to be included within the shaped rate of the customer 32, then whenever the flow coupling module 18 observes data transmissions from the voice queue 24, the flow coupling module 18 will transmit the modification request message 4a to the MAR 40. In this case the modification request message 4a may indicate the length of packet transmitted from the voice queue 24. After the shaper/scheduler 16 has absorbed the information in the MAR into the rate calculation/fairness calculation, the flows will have been effectively coupled together from a transmission rate perspective. It may be necessary in some system implementations to limit the rate of data flow from the flows which are coupled into a target flow either through rate scheduling or policing to an aggregate rate lower than the target flow's configured rate.

An output modification module 20 of FIG. 1 embodies a further exemplary application for the flow management. The output modification module 20 monitors packet flows and chooses when to correct the characteristics of a packet which has already been transmitted from the shaper/scheduler 16.

For example, the difference in size of the packet seen by the shaper/scheduler 16 and that transmitted on the line represents an error in rate or fairness within the scheduler. The output modification module 20 observes a frame size, and calculates the modification amount as the difference between the observed frame size and the frame size that was assumed by the scheduler. The output modification module 20 sends a modification request message 4b associated with the modification amount back to the MAR for the customer from which the packet came. In this case, the modification request message 4b may include a positive or a negative value, indicating the rate/fairness may have been influenced toward too much data or too little data transmitted from the customer. For example, the flow transmission system 10 grants extra transmits capacity based on the negative value.

A flow control module 22 of FIG. 1 embodies a further exemplary application for the flow management. The flow control module 22 monitors downstream resource for flow control. The flow control by the flow control module 22 is implemented by applying the modification amount corresponding to excess data in the downstream resource to the flow that feeds the downstream resource.

For example, the downstream resource monitored by the flow control module 22 may be, but is not limited to, a queue which may be congested. When the queue is congested, the flow control module 22 may generate a rate modification request 4c indicating that a reduction in rate is required toward this queue. The flow control module 22 does not directly request a time pause (as in Ethernet flow control) or a stop request (as in XON/XOFF flow control). The flow control module 22 requests an amount of data which should not be transmitted at the current shaper configuration which depending upon the attributes of the rate scheduler may effect an equivalent time gap, or a rate change for an equivalent time gap. This particular embodiment does not apply for weighted fair schedulers, however, is usefull for flow controlling rate schedulers.

In FIG. 1, each of the flow control module 18, the output modification module 20, and the flow control module 22 is depicted in the downstream direction of data flow. However, these application modules 18-22 or any part of the application modules may reside at different points in the system, such as integrated into the traffic shaper/scheduler 16. For example, the flow coupling module 18 maybe integrated into the traffic shaper/scheduler 16.

In this embodiment, the MARs provide the information database for coupling the flow control, rate modification information or a combination thereof from the system monitor 2 to the traffic shaper/scheduler 16. The modification request message may be a flow control request or a flow gap request. A MAR may exist for each customer or shaped entity which requires flow control, rate modification or a combination thereof. A MAR may exist for a group of customers. The system monitor 2 makes decisions to flow-control, rate-modify a customer flow or a combination thereof, and sends one or more than one modification request messages (4a, 4b, 4c of FIGS. 1, 4 of FIG. 2).

During the operation, the application modules such as modules 18, 20 and 22 may be added to the system monitor 2 or be subtracted from the system monitor 2.

Further exemplary applications for the flow management are as follows:

When shaping towards an unpredictable link bandwidth, such as links using the High-Level Data-Link Control (HDLC) encapsulation formula which lose bandwidth to encoding and bit/byte stuffing, adjusting the MAR maybe triggered from a monitor co-located with the HDLC input queue and used to gap the traffic destined to the HDLC input queue to effect a lower rate. Using a rate scheduler together with the MAR to feed the HDLC channels enables highly scalable flow control for channelized applications.

When bypassing latency and jitter sensitive data around a customer rate scheduler, the rate scheduler can incorporate the bypassed data into the rate calculations using the MAR, affecting an overall customer rate through the customer rate scheduler. This is referred to as the flow coupling application. Accordingly the MAR enables low jitter bypass of jitter sensitive data when facing a customer (subscriber to a low jitter service).

When modifying the data downstream of the traffics shaper/scheduler 16 the shaped rate of the customer can be modified to account for the downstream modifications through the MAR. One such modification requirement may include the conversion between fixed size cells or frames to variable length frames, sometimes called becoming byte accurate or byte aware. This includes but is not limited to ATM cells, frame segments, and fame fragments being converted to frames. Another modification may include the addition or deletion of headers or trailers to the packet or the fragmentation of a packet into two parts (requiring a duplication of headers and trailers).

The flow transmission system 10 may be a router. The flow transmission system 10 may be implemented in, for example, but not limited to, a router such as a Nortel Networks Multi-Service Provide Edge Router Family for implementing features described herewith, which include a coupling of flows at the rate level even if they are scheduled independently. It is apparent to a person skilled in the art that the modification mechanism is applicable to any flow control systems other than a router, for example, packet switches, cell switches, subscriber access, wireless access, etc.

FIG. 2 illustrates an example of a portion of the traffic shaper/scheduler 16, and a MAR module applied to the rate scheduler.

The shaper/scheduler 16 includes a rate scheduling circuit 44. The rate scheduling circuit 44 selects the next customer to transmit data from among the set of customers associated with a rate scheduler and which have data and are eligible to send at the current time. The rate scheduling circuit 44 may contain control lists, search trees, or calendar lists to maintain the transmit eligibility time of each customer and to provide fairness between eligible customers. In FIG. 2, calendar lists 46 are illustrated as an example.

The traffic shaper/scheduler 16 may include modules/entities other than the rate scheduling circuit 44. For example, the rate scheduling circuit 44 may be replaced with a sort circuit(s) which is used to find the earliest eligible customer or entity. The rate scheduling circuit 44 may be replaced with a weighted fair scheduling circuit(s) which is used to arbitrate relative rate between different customers.

In FIG. 2, the second customer 34 associated with the rate scheduler 38 is selected for transmission as represented by dotted lines 48 and 49 (hereinafter referred to as scheduler selection load request 48, 49). However, the first customer 32 of FIG. 1 or any other customer or entity not depicted in FIG. 1 may be selected for transmission. FIG. 2 depicts a context swapping scheduler, where a single rate scheduling circuit can be used to perform a calculation for any customer's flow depending upon which context is loaded. However, the shaper/scheduler 16 is not limited to a context based shaper/scheduler.

A MAR set 50 represents a set of MARs for all customers, including the MARs 40 and 42 of FIG. 1, and a loaded customer MAR 43. The MAR set 50 provides a set of in boxes for information fed back from downstream, upstream, adjacent or otherwise located processes, such as flow coupling 18 of FIG. 1, output modification 20 of FIG. 1, and flow control 22 of FIG. 1, depending on the application.

The rate scheduler 38 retrieves the customer context 45 for the scheduling event from amongst the configured and dynamic state of all of the customers in response to the scheduler selection load request 48. In FIG. 2, the specific context for the customer currently being loaded is labeled as “53”.

When the rate scheduler 38 selects (“wakes up”) a flow for the purpose of selecting data for transmission, it uses the contents of the corresponding MAR to modify the configured and dynamic state 53 associated with the selected flow. In FIG. 2, the customer 34 is selected. In response to the customer selection, the customer context associated with the selected customer 34 is loaded into the MAR 43 from a selected customer MAR among the MAR set 50. In FIG. 2, the content of the MAR 42 for the customer 34 is loaded to the MAR 43. The loading and storing of the MAR 43 from and to the MAR in the MAR set 50 is synchronous to rate scheduler activities of the rate scheduler 38, and is triggered by the scheduler selection load request 49.

The entity's dynamic state 53 absorbs the MAR 42 through the MAR 43. The rate scheduler 38 consumes into the customer context 45 all or part of the value in the MAR 43. Any remaining value in the MAR 43 is stored back to the MAR 42 in the MAR set 50 for continued collection of external modification requests.

The customer context 45 may include, among other states, the configured rates and the dynamic state associated with past performance against desired rate. Also information associated with the frame at the head of queue 30, such as length of this frame, is loaded into the scheduler context 45 in response to the customer selection.

When using cascaded schedulers, the customer context 45 may include a set of control data structures to select queue 30 or a child scheduler which could be called up to select queue 30.

The rate scheduler 38 uses the contents of the MAR 42 during rate calculations, and subsequent modification of the shaped entities dynamic state 53, as if the current frame being scheduled is of a different length than its actual length by the amount of the MAR 42. Thus, the MAR 42 can affect the rate of the entity, the burst capability of the entity or a combination thereof, depending upon the rate shaping algorithm employed by the rate scheduler 38 and the dynamic state 53 of the entity being rate shaped. In the case of using a MAR implementation to modify the fairness of a weighted fair scheduler, the MAR can similarly be regarded as a length modifier of the current frame being scheduled, resulting in a modification of the scheduler fairness between customers by the amount within the MAR.

As will be appreciated by one of skill in the art, absorbing the MAR 42 includes modifying the next eligble transmission time or modifying a burst counter, and may also include modifying other parameters of the entity state depending upon the rate shaper implementation used.

A burst tolerance is a rate scheduler concept to represent the amount of data which can be transmitted at a first configured rate before reverting to a second configured rate. A burst counter is dynamic state to track how much of the burst tolerance has been consumed. In the case of a customer which is configured with a large burst tolerance, a modification request message 4 may request a gap in data which entirely fits within the burst tolerance, overflows the burst tolerance, or arrives at a customer which has previously exhausted its burst tolerance. In the cases where the burst tolerance has been consumed, the rate scheduler may reduce the shaped rate of the customer. In cases where the burst tolerance has not been consumed, the rate scheduler 44 may continue transmitting at the previous rate. However the new burst counter level may cause a future transmission event to trigger the reduction in shaped rate.

A MAR update circuit 51 receives a modification request message(s) 4 from the system monitor 2 of FIG. 1, and updates the amount of the corresponding MAR (e.g. 42) in the MAR set 50 asynchronously to the rate scheduler activities, without direct intervention of the rate scheduler (e.g. 38). The MAR update circuit 51 also manages a request from the rate scheduler 38 to modify the MAR set 50. The MAR update circuit 51 may add to or subtract from the existing amount of the MAR based on information received from the scheduler 38 or the system monitor 2 of FIG. 1.

The MAR update circuit 51 enables downstream or adjacent processes (e.g. system monitor) and the scheduling circuit 44 to request or affect a modification to the MAR associated with a specific customer directly into the appropriate location within the MAR set 50.

The asynchronous management and consumption of the MAR 42 allows additional downstream functionality, such as additional levels of scheduling or frame modification, etc to be added without impacting the complexity of the first order rate scheduler algorithm. With new context update algorithms, which are outside the primary complexity concerns of the rate scheduling algorithm of the rate scheduling circuit 44, one can modify the customer context. The new modified customer context can include the gaps requested by the downstream or adjacent processes.

The MAR update circuit 51, which may include a plurality of update circuits and is co-located with the MAR set 50, consumes messages 4 from the separate processes to make the interface with MAR more generic and transparent and to avoid any coherency issues with the rate scheduling circuit 44. For example, two or more than two MAR update circuits may take turns modifying the MAR values so that there is no conflict between sources of modification requests.

The rate scheduler 38 and the modification request message 4 may request a change to the same flow. The MAR update circuit 51 is responsible for coherency between the customer context loaded into the MAR 43 and the modification request message 4 to modify the MAR set 50. For example, the MAR update circuit 51 monitors or examines the load request 49 to avoid corruption of a MAR by a request from the system monitor 2 and a request from the rate scheduler 38.

The flow management mechanism is applicable to allow a flow to slow down where the rate scheduling circuit 44 has sent data too fast on a specified flow and needs to slow the flow down. The modification mechanism is also applicable to allow a specific flow to speed up. The MAR update circuit 51 may assign to an element of the s MAR set 50, a value for “speed up”, “slow down”, “pause for a time (expressed as an overshoot amount)”, or “send sooner by a time (expressed as an undershoot amount)”. For example, the value may be a positive which corresponds to a request for a specific flow to slow down. The value may be a negative which corresponds to a request for a specific flow to speed up.

The traffic shaper/scheduler 16 of FIG. 2 provides for the behaviors of a plurality of corner cases; a corner case 1 where the parameter of the MAR 42 is more negative than the length of the current frame and the remaining burst capability of the entity, and a corner case 2 where the parameter of the MAR 42 plus the length of the current frame results in a scheduling event further into the future than the rate shaper's longest supported event horizon.

The behaviors for the corner case 1 may include, but are not limited to, one or more of scheduling immediately, entering the calendar table 46 in the immediate next slot in the case where the implementation of the rate scheduler is calendar or time-wheel based, and reducing the burst counters for the entity. In this instance, the MAR 42 is modified as a result of the change in rate scheduler behavior to incorporate MAR, however, the MAR 42 is not necessarily cleared.

The behaviors for the corner case 2 may include, but are not limited to, one or more of scheduling to the end of the event horizon for a calendar or time-wheel implementation, increasing the burst counters for the entity, and not sending the current frame which is supposed to be sent as part of this rate scheduler event. As will be apparent to one of skill in the art this last behavior, not sending the current frame, may require modifications which extend beyond the context update algorithm 44, including in the areas of queue management and the dequeuing data path Similarly to the corner case 1, the MAR 42 is modified as a result of the change in shaper behavior, however, is not necessarily cleared.

In FIG. 2, the MAR update circuit 51 is shown separately from the MAR set 50. However, the MAR update circuit 51 may be a part of the MAR set 50. The MAR update circuit 51 may be a part of the traffic shaper/scheduler 16. The MAR update circuit 51 and the MAR set 50 are applicable to any of scheduling algorithms to modify the algorithm fairness between customers, rate of a customer, or to insert a gap in a flow.

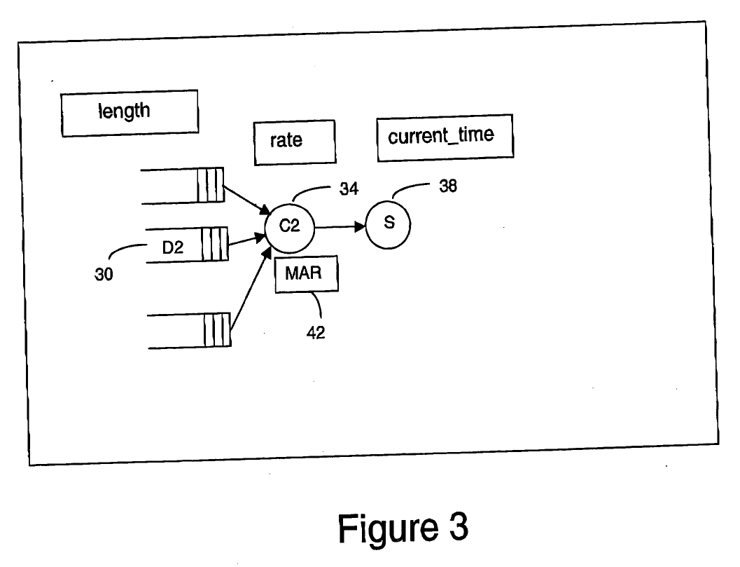

FIG. 3 illustrates an example of a rate shaping algorithm applied to the rate scheduler 38 of FIG. 1. The rate shaping algorithm of FIG. 3 is a first order shaping algorithm which is a simple time wheel single rate shaper as is known in the art. It is noted that rate shaping algorithm applied to the rate scheduler 38 is not limited to a first order shaping algorithm of FIG. 3, and may include, but not limited to, dual rate shaping and single rate with burst tolerance algorithms as are known in the art, among others.

One example rate calculation algorithm which may be employed is as follows:
next_time=current_time+frame_length/rate (1)
where “next_time” is a time in the future when this customer will be eligible to send its next frame, “current_time” is the wall clock time at the time of the calculation, “frame_length” is the length of the frame being transmitted by this scheduling operation, and “rate” is the configured customer rate which the rate scheduler is using for this customer, The algorithm (1) calculates the next time when a customer is eligible to transmit data without the MAR 42.

According to the embodiment of the present invention, the MAR 42 value can be incorporated into this calculation (1) as follows:
next_time=current_time+(frame_length+MAR)/rate (2)
where all parameters are the same definition as above, and MAR is expressed in the same units as the frame length.

As is obvious to one who is skilled in the art, the specifics of the computation varies with the rate shaping algorithm, the accuracy of parameters and the specifics of the MAR feedback. In many algorithms, it may be required that the value of (frame_length+MAR) falls within a range of values in order for the calculation to get the desired result. This is the case where only part of the MAR can be absorbed and the remainder is returned to the MAR for a fixture scheduling event.

According to this modified context update algorithm, the rate scheduler 38 calculates the earliest next time to send data for a customer or shaped entity based on the following:

1) Traditional shaper settings for the customer data rate, burst size, previous requested transmission time, etc.

2) MAR for the customer containing the amount of data that downstream or neighboring processors have requested as a gap.

3) wherein the requested gap occurs after the next transmission event for that customer or distributed over future transmission events for that customer.

The traffic shaper/scheduler, the system monitor, the MAR and the MAR update circuit in accordance with the embodiment of the present invention may be implemented by any hardware, software or a combination of hardware and software having the above described functions. The software code, instructions and/or statements, either in its entirety or a part thereof, may be stored in a computer readable memory. Further, a computer data signal representing the software code, instructions and/or statements, which may be embedded in a carrier wave may be transmitted via a communication network. Such a computer readable memory and a computer data signal and/or its carrier are also within the scope of the present invention, as well as the hardware, software and the combination thereof.

The present invention has been described with regard to one or more embodiments. However, it will be apparent to persons skilled in the art that a number of variations and modifications can be made without departing from the scope of the invention as defined in the claims.

What is claimed is:

1. A system for data transmission, comprising:
a scheduler for implementing scheduling to select a data flow for transmission;
a system monitor for determining one or more than one target flow and a modification amount for each target flow; and
a modification amount register for holding the total modification amount for each target flow as the system monitor requests modification and the scheduler consumes the modification,
the scheduler being configured with the transmission characteristics of each flow including the one or more than one target flow, to select the transmission order of flows independently of the modification amount register, and being capable of altering the transmission characteristics of a selected flow which is a target flow, based on the modification amount stored in the modification amount register of the target flow.

2. A system according to claim 1, wherein the scheduler applies the modification amount for the target flow to the selected flow when the scheduler selects the target flow for the transmission, and consumes the modification amount stored in the modification amount register of the target flow.

3. A system according to claim 2, wherein the scheduler is capable of consuming at least part of the contents of the modification amount register in a scheduling event, the remainder of the modification amount being in the modification amount register for a subsequent scheduling event.

4. A system according to claim 2, wherein the scheduler includes a rate scheduler where the modification amount effects a change in rate in a manner similar to that of a change in length of the packet in the current scheduling event,

5. A system according to claim 4, wherein the modification amount register has enough resolution to accommodate modification amounts of the same magnitude as the maximum transmission unit of the target flow.

6. A system according to claim 2, wherein the scheduler includes a weighted fair scheduler where the modification amount effects a change in remaining weight or deficit in weight in a manner similar to that of a change in length of the packet in the current scheduling event.

7. A system according to claim 1, wherein the system monitor provides flow coupling by applying the amount of data sent by one or more flows to the modification amount register of the target flow.

8. A system according to claim 7, wherein the system monitor uses an identifier of the one or more flows to calculate or lookup the identifier of the target flow.

9. A system according to claim 8, wherein the one or more flows and the target flow represent a customer, and the scheduling behavior for the target flow represents the overall customer fairness or rate limit.

10. A system according to claim 9, wherein the target flow is configured with a rate limit which is at least as large as the rate achieved by all of the one or more flows coupled into the target flow.

11. A system according to claim 9, wherein the target flow is configured with a rate limit which is at least twice as large as the rate achieved by all of the one or more flows coupled into the target flow and the modification amount register is dimensioned to accommodate at least as much data as the maximum transmission unit of the customer.

12. A system according to claim 9, wherein the one or more flows being coupled into the target flow represent jitter sensitive data, and the target flow represents the rest of the customer data which is less jitter sensitive.

13. A system according to claim 12, wherein the one or more flows being coupled into the target flow include voice packets.

14. A system according to claim 1, wherein the system monitor provides flow control by applying a modification amount corresponding to excess data in a downstream resource to a flow that feeds the downstream resource

15. A system according to claim 1, wherein the system monitor provides correction of frame length by observing downstream changes to the frame length and applying the change in length to the modification amount register for the same flow.

16. A system according to claim 11, wherein the system monitor calculates the modification amount as the difference between the scheduler's assumed frame length and the actual observed frame length.

17. A system according to claim 1, wherein the modification amount register includes an update circuit for communicating with the system monitor and updating the modification amount register.

18. A system according to claim 13 wherein the update circuit is capable of adding to or subtracting from the existing modification amount based on information received from the scheduler or the system monitor

19. A system according to claim 17, wherein the update circuit provides to the scheduler the current value of the modification amount register for the selected flow.

20. A system according to claim 17, wherein the update circuit implements resolving conflicts in updating the modification amount register when the scheduler and the system monitor request a change to the same flow.

21. A system according to claim 2, wherein the modification amount register includes an amount of data to increase the target flow by, an amount of data to decrease the target flow by, or both.

22. A method for data transmission, comprising the steps of:
at a scheduler, implementing scheduling to select a data flow for transmission;
determining one or more than one target flow for an application and a modification amount for each target flow, and generating a modification request associated with the modification amount, independently of the scheduling, and
updating a modification amount register for each target flow based on the modification request, independently of the scheduling, to modify the behavior of the scheduler using the modification amount register of a target flow when the scheduler selects the target flow for the transmission.

23. A method according to claim 22, wherein the application is for a flow coupling, and further comprising the step of:
modifying the behavior of the scheduler by applying the amount of data sent by one or more flows to the modification amount register of the target flow.

24. A method according to claim 23, wherein the application is for a flow control, and further comprising the step of:
modifying the behavior of the scheduler by applying a modification amount corresponding to excess data in a downstream resource to a flow that feeds the downstream resource.

25. A method according to claim 23, wherein the application is for correction of frame length, and further comprising the step of:
modifying the behavior of the scheduler by applying a modification amount corresponding to observed downstream changes to the frame length for the same flow.

26. A method according to claim 23, further comprising the step of:
at the scheduler, consuming the modification amount stored in the modification amount register of the target flow when the scheduler selects the target flow for the transmission.
